(19) United States
(12) Patent Application Publication
(10) Pub. No.: US 2020/0055227 A1
(43) Pub. Date: Feb. 20, 2020

(54) Vent Type Extruder and Method of Manufacturing Cable Jacket Using the Same

(71) Applicant: CORNING OPTICAL FIBER CABLE (CHENGDU) CO. LTD, Corning, NY (US)

(72) Inventors: Chao-Yin Chuang, Taichung City (TW); Xiaopan Cui, Chengdu (CN); Li Feng, Chengdu (CN); Zhi Ming Liu, Shanghai (CN)

(21) Appl. No.: 16/663,933

(22) Filed: Oct. 25, 2019

Related U.S. Application Data
(63) Continuation of application No. PCT/CN2017/082437, filed on Apr. 28, 2017.

(51) Int. Cl. B29C 48/76; H01B 13/24; B29C 48/154; B29C 48/37; B29C 48/375

(52) U.S. Cl. CPC B29C 48/763; H01B 13/24; B29L 2031/3462; B29C 48/37; B29C 48/387; B29C 48/154

(57) ABSTRACT

A cable jacket extruder comprises a chamber, a feeding port disposed at one end of the chamber, an extruding screw disposed inside the chamber, a pathway connected to an outlet at another end of the chamber, wherein a vent is defined on the pathway, and a nozzle connected to the pathway. In another example, a tandem-type cable jacket extruder is provided. The tandem-type cable jacket extruder comprises a first chamber and a second chamber connected in tandem via a pathway, a vent disposed on the pathway, a feeding port disposed at one end of the first chamber, and an extruding screw disposed in each of the first and second chambers. A method for manufacturing cable jackets is also provided.

### CROSS-REFERENCE TO RELATED APPLICATIONS

This application is a continuation of International Application No. PCT/CN2017/082437, filed Apr. 28, 2017, the content of which is relied upon and incorporated herein by reference in its entirety.

### BACKGROUND

The disclosure relates to an extruder, and more particularly to an extruder with vent for allowing volatiles inside materials to escape through.

Being cost-effective and environmental friendly, recycled polymer materials are utilized in the manufacture of cable jacket. The recycled polymer materials go through compounding, pelleting, and are then shipped for storage in a plant silo. The recycled polymer material pellets are dried through hot air drying before the cable jacket extrusion and manufacturing process. Nonetheless, moisture and various types of volatiles are contained in the recycled polymer materials. If the volatiles cannot be removed efficiently in the manufacturing process, e.g., through hot air drying and the extrusion, the volatiles will become pin holes in the cable jacket layer. In some countries, visible pin holes are not allowed in cable jackets.

Extruders are typically used for pellet compounding and pellet processing in the manufacture of the cable jacket. Polymer materials are melted and formed into a continuous profile. The process starts by feeding polymer materials (in pellets, granules, flakes or powders) from a feeding port (e.g., a hopper) into a chamber of the extruder. The polymer materials are gradually melted by mechanical energy generated through turning extruding screws inside the chamber and by heaters arranged along the chamber. The molten materials are then forced into a die, which shapes the materials into a cable that hardens during cooling. To remove the volatiles in the recycled polymer materials, vent is introduced on a chamber of the extruder providing an exit for volatiles to escape from the recycled polymer materials.

To open a vent on a conventional extrusion chamber, it is expected that the length of the extruder is generally going to be extended for sake of operation stability and homogenization. In other words, a longer and particularly-designed screw would be required to prevent the materials from overflowing from the vent and to increase melt consistency. Therefore, a conventional extruder provided with a vent would require a larger length to diameter (L/D) ratio compared to the conventional extruder without vent.

There is a need for an extruder with sufficient venting capabilities in cable jacket manufacturing with recycled polymer materials that does not require extending the length of the extruder.

### SUMMARY

The present disclosure involves a vent-type extruder with a shortened L/D ratio that is comparable to extruders without vents. The present disclosure also provides methods for forming or manufacturing cable jackets with recycled polymer materials, using the vent-type extruders as disclosed herein.

One embodiment of the present disclosure relates to a cable jacket extruder that includes a chamber, a feeding port disposed at one end of the chamber, an extruding screw disposed inside the chamber, a pathway connected to an outlet at another end of the chamber, the pathway having a vent, and a nozzle connected to the pathway.

In another embodiment, a tandem-type cable jacket extruder includes a first chamber and a second chamber connected in tandem via a pathway, a vent disposed on the pathway, a feeding port disposed at one end of the first chamber, and an extruding screw disposed in each of the first and second chambers.

In still another embodiment, a method for manufacturing a cable jacket includes the following steps: feeding recycled polymer materials into an extrusion chamber, extruding the recycled polymer materials with an extruding screw which conveys the recycled polymer materials along the extrusion chamber, ventilating the extrusion chamber through a pathway disposed at an outlet of the extrusion chamber, allowing volatiles inside the recycled polymer materials to escape from the extrusion chamber, and conveying the recycled polymer materials through a nozzle connected to the pathway to form the cable jacket.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a cable jacket extruder according to embodiments of the present disclosure;

FIGS. 2A and 2B are top views of various types of vents according to embodiments of the present disclosure;

FIG. 3 is a gear pump according to embodiments of the present disclosure;

FIG. 4 is a cable jacket extruder with a kneading roller according to embodiments of the present disclosure;

FIG. 5 is a cable jacket extruder with multiple screws according to embodiments of the present disclosure;

FIG. 6 is a barrier screw according to embodiments of the present disclosure;

FIGS. 7A and 7B are cross sections of different types of barrier screws;

FIGS. 8A and 8B are different types of multiple-flight screws;

FIGS. 9A and 9B are tandem-type extruders according to embodiments of the present disclosure; and

FIG. 10 is a flow diagram of a method for forming cable jackets according to embodiments of the present disclosure.

### DETAILED DESCRIPTION

Reference will now be made in detail to the present embodiments of the disclosure, examples of which are illustrated in the accompanying drawings. Wherever possible, the same reference numerals will be used throughout the drawings to refer to the same or like parts.

Unless otherwise defined, all terms used in this specification and claims generally have their ordinary meaning in the art, within the context of the disclosure, and in the specific context where each term is used. Certain terms that are used to describe the disclosure are discussed below, or elsewhere in the specification, to provide additional guidance to the practitioner regarding the description of the disclosure. The singular forms “a,” “an” and “the” used herein include plural referents unless the context clearly dictates otherwise. Therefore, reference to, for example, a vent includes embodiments having two or more such vents, unless the context clearly indicates otherwise. Reference throughout this specification to “one embodiment” or “an embodiment” means that a particular feature, structure, or characteristic described in connection with the embodiment is included in at least one embodiment of the present disclosure. Therefore, the appearances of the phrases “in one embodiment” or “in an embodiment” in various places throughout this specification are not necessarily all referring to the same embodiment. Further, the particular features, structures, or characteristics may be combined in any suitable manner in one or more embodiments. It should be appreciated that the following figures are not drawn to scale; rather, these figures are intended for illustration.

It also will be understood that, although the terms first, second, third etc. may be used herein to describe various elements, components, regions, layers and/or sections, these elements, components, regions, layers and/or sections should not be limited by these terms. Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The object may be otherwise oriented (rotated 90 degrees or at other orientations) and the spatially relative descriptors used herein may likewise be interpreted accordingly.

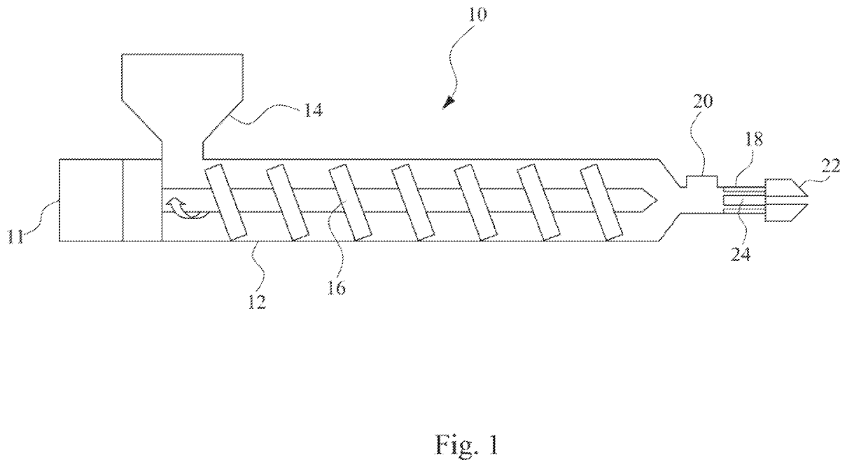

FIG. 1 shows a vent-type cable jacket extruder 10 according to one embodiment of the present disclosure. The extruder 10 comprises a chamber 12, a feeding port 14 disposed at one end of the chamber 12, an extruding screw (or simply referred to as “screw”) 16 disposed inside the chamber 12, a pathway 18 with a vent 20 connected to an outlet at another end of the chamber 12, and a nozzle 22 connected to the pathway.

Materials such as recycled polymer pellets or other suitable materials for forming cable jackets may be fed into the chamber 12 through the feeding port 14, which may be a hopper in one example. Once inside the chamber, the materials will be conveyed along the chamber by the screw 16, which is rotated by a motor 11 or any other suitable actuating device. Heaters (not shown) may be positioned along the chamber 12 to facilitate melting of the materials. The process of melting and conveying materials along the chamber 12 may release volatiles contained in the materials. The released volatiles can escape the extruder through the vent 20 defined on a pathway 18 connected to an outlet of the chamber 12. In an embodiment, a screen pack 24 may be disposed in the pathway for filtering and improved mixing. The nozzle 22 comprises a die with the shape of the cable jacket, so that materials conveyed through the nozzle may be formed into the shape of a cable jacket, for example.

In some embodiments, the materials can be pre-dried by a dehumidifier before entering the extruder for reducing volatiles carried by the materials. The dehumidifier may operate through using a “honeycomb rotor” in a closed loop system. The honeycomb rotor can be divided into a process zone and regeneration zone, and constantly rotates at a rotation speed by a motor. Process air with high moisture enters the process zone to contact the rotating honeycomb rotor. Honeycomb adsorbents in the rotor absorb moisture as air passes through the honeycomb channels, forming dry air. The honeycomb rotor with absorbed moisture enters the regeneration zone by rotation. The rotor is regenerated by hot air passing through the honeycomb channels, allowing the absorbed moisture to evaporate, and turns again to the process zone. This cycle continues in order to remove moisture from air. In the pre-drying process, the dehumidifiers generally have better moisture removing capabilities than hot air dryers according to embodiments of the present disclosure.

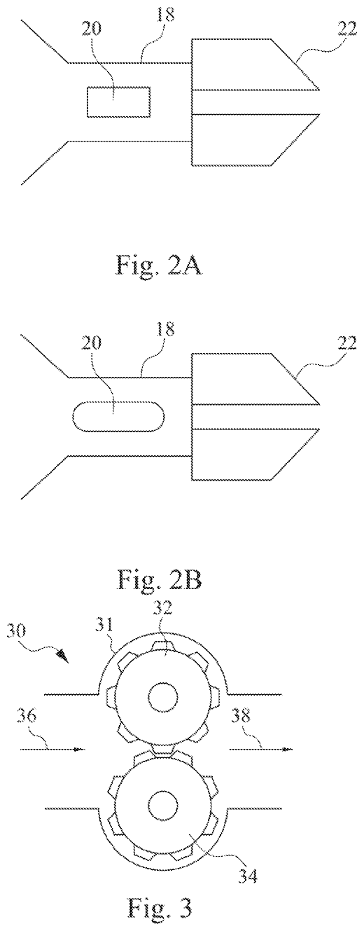

FIGS. 2A and 2B show embodiments of the vent 20 that can be defined on the pathway 18. The pathway 18 refers to a connecting portion that has no screw accommodated therein. As seen in the top view of FIG. 2A, the vent 20 can be rectangular in shape, with a long length or long axis extending along the pathway. In another embodiment as seen in FIG. 2B, the vent 20 can have an oval shape, with a long length or long axis extending along the pathway.

According to the embodiments of the present disclosure, the vent 20 is designed in a way that materials do not overflow from the vent 20. The velocity of gas and/or vapors flowing out of the vent 20 is a function of material volume flow rate and the vent open area. If the gas and/or vapor velocity leaving the vent is too high (e.g., as a result of too much material volume flow rate through the pathway 18 or too little open area of the vent 20), the exiting gases will tend to push material melt out of the vent 20. Additional vents may be opened on the pathway. In some embodiments, the contour of the vent may optionally be raised to form a wall for preventing materials from overflowing. In some embodiments, a specific shape of the vent may be introduced to maximize the material volume flow rate.

Extruders with the vent defined on the pathway at an outlet of the chamber can have an L/D ratio in the range of 25 to 50, for example, 25. On the other hand, extruders with the vent defined on the chamber (i.e., above the screw) typically have an L/D ratio in the range of 35 to 50, for example, 35. The L/D ratio is defined as the flighted length of the extruding screw to its outside diameter. If the extruder chamber has similar dimensions as the extruding screw, the L/D ratio of the screw may approximate the extrusion chamber.

In some embodiments, the vent can be connected to a powered ventilating device (not shown), for example a fan or a vacuum pump, for facilitating discharge of volatiles inside the chamber. Also, the vacuum pump may ventilate the chamber through the vent under negative pressure, for example, −0.06 MPa or lower. In embodiments, the powered ventilating device provides sufficient ventilation such that the recycled polymer materials do not have to go through hot air drying before being fed into the extruder.

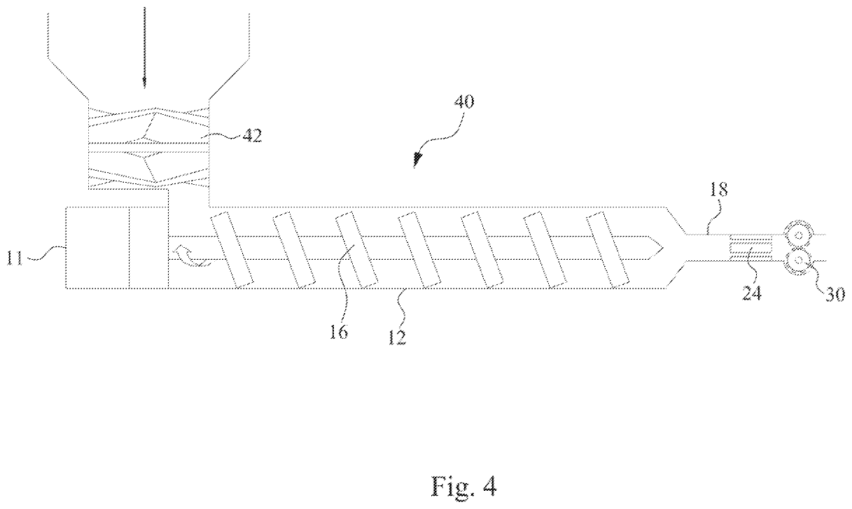

In some embodiments of the present disclosure, a gear pump or melt pump may be connected between the pathway and nozzle for controlling output of materials. FIG. 3 shows a schematic section view of a gear pump 30. Gear pumps comprise two gear wheels 32, 34, which are usually driven by a motor (not shown). The extruder conveys the materials into the gear wheels 32, 34 from the gear wheel inlet 36, and the rotating gear wheels 32, 34 discharge materials at the outlet 38. When the gear wheels 32, 34 are tightly fitted in a housing 31, each tooth of the gear wheels 32, 34 will contain a near constant volume of materials. As the gear wheels 32, 34 work, they facilitate the accurate amount of polymers at the outlet 38 output to the die for making the cable jacket.

Optionally, gear pumps can be monitored through a monitoring system (not shown) comprising sensors and displays. For example, the monitoring system can monitor inlet and outlet pressures, motor driving power, and temperature, as well as other parameters associated with the gear pump. The monitored parameters may provide feedback for output control.

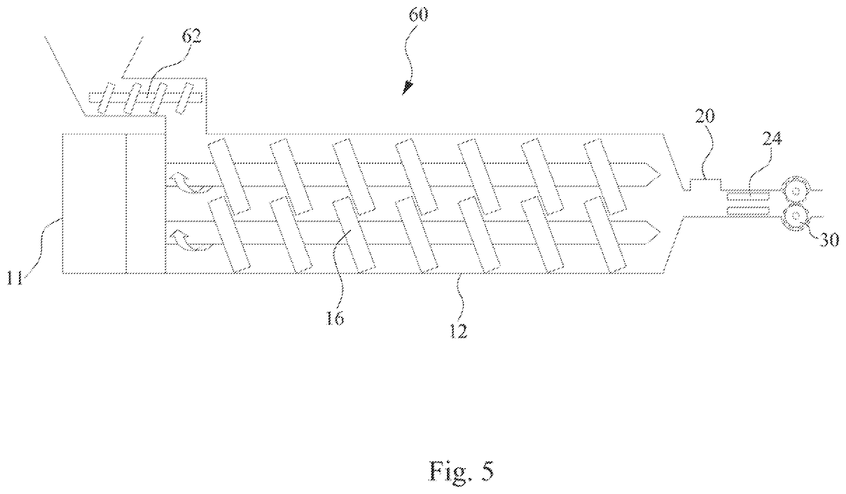

In another embodiment, the feeding port comprises a kneading roller for forcing volatiles out of the materials before entering the chamber. FIG. 4 shows a schematic view of an extruder 40 with a kneading roller 42. Extruder 40 functions in a similar manner as described above, yet the input materials will pass through kneading rollers 42 at the feeding zone before entering the chamber 12. Kneading rollers 42 include counter-rotating rollers aligned across the feeding port, squeezing materials that pass through the gap between the respective rollers, hence forcing volatiles out of the material. The kneading rollers 42 may have V-shaped blades and a triangular cross-section; however, other types of kneading rollers may also be used. Additionally, while not shown in FIG. 4, vents can also be disposed on the pathway 18 or on the chamber 12.

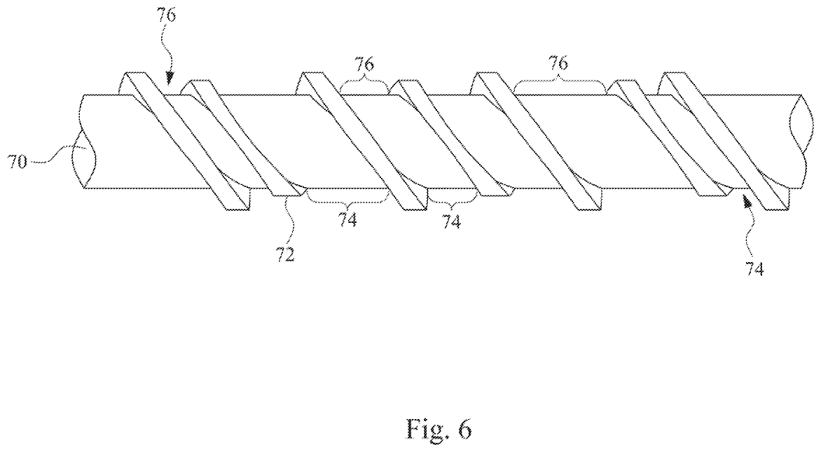

FIG. 5 shows an alternative embodiment of the extruder 60 according to the present disclosure. The extruder of FIG. 5 functions similarly to the extruder of FIG. 1, with a screw 62 positioned before the feeding port for controlling the amount of material that enters the extrusion chamber. Furthermore, multiple screws 16 may be positioned inside the chamber. While FIG. 5 shows an extruder with two screws 16, it is possible for extruders to have more than two screws. In one example, an extruder comprises eight screws.

In some embodiments, the screw that is positioned in the extrusion chamber comprises at least one of a barrier flight, an inverse flight, and multiple flights, which will be described in detail below.

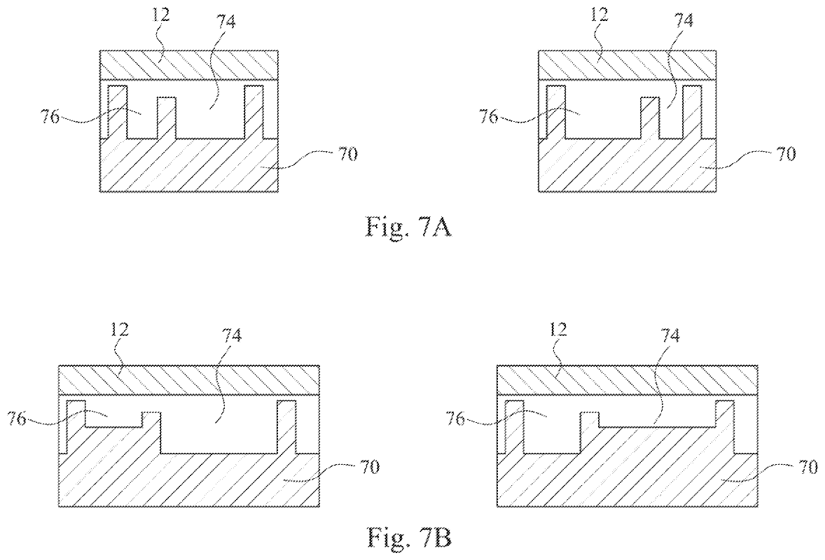

One embodiment of a screw with barrier flights, or herein referred to as “barrier screw” is shown in FIG. 6. As mentioned earlier, solid materials in the form of pellets or other forms enter the extruder and are melted as the materials travel along the chamber, either by mechanical energy generated through turning the screws inside the chamber and/or by heaters arranged along the chamber. However, in some instances it is possible for the solids to remain unmelted in the chamber and clog the pathway 18 or other structures of the extruder. To ensure melting quality, barrier screws can be used to separate solids and melts inside the chamber.

As seen in FIG. 6, the barrier flight 72 divides the screw channel into a solids channel 74 and a melt channel 76, wherein the barrier screws keep unmelted solids in the solids channel 74, while letting the fluid melt escape over the barrier flight 72 into the melt channel 76. The solids channel 74 reduces along the length of the barrier section while at the same time the melt channel 76 increases; therefore, melted material is forced over the barrier flight 72 into the melt channel 76.

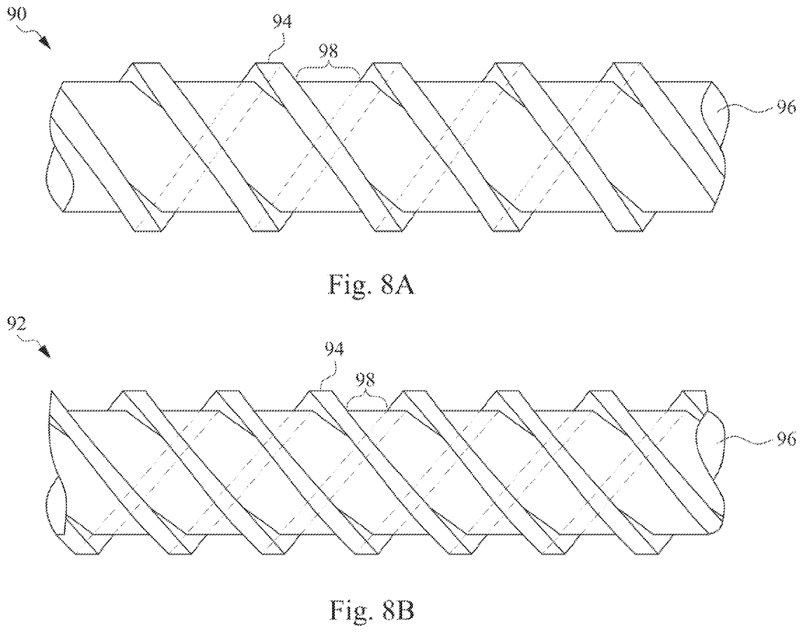

Two configurations of the barrier flight are shown in FIG. 7A and FIG. 7B according to the embodiments of the present disclosure. FIG. 7A is referred herein as a constant depth barrier flight design and FIG. 7B is referred herein as a constant width flight design. In the constant depth design of FIG. 7A, the depths of the solids channel 74 and melt channel 76 remain unchanged, while the width of the solids channel 74 becomes narrower along the length of the screw and the melt channel 76 becomes wider. In the constant width design of FIG. 7B, the widths of the solids channel 74 and melt channel 76 remain unchanged throughout the barrier flight section while the solids channel 74 decreases in depth and the melt channel 76 increases in depth. Other designs of the barrier flight are possible; for example, it is possible for the melt channel 76 and solids channel 74 to have both varying widths and depths.

Inverse screw flights (not shown) have flights disposed in an orientation opposite to the other flights on the same screw, causing melt liquid to flow in an opposite direction. For example, if the screw flights are mainly designed in a counter-clockwise orientation, then the inverse flights will be oriented in a clock-wise manner. Such configuration increases mixing time and can prevent materials overflowing a certain section of the screw.

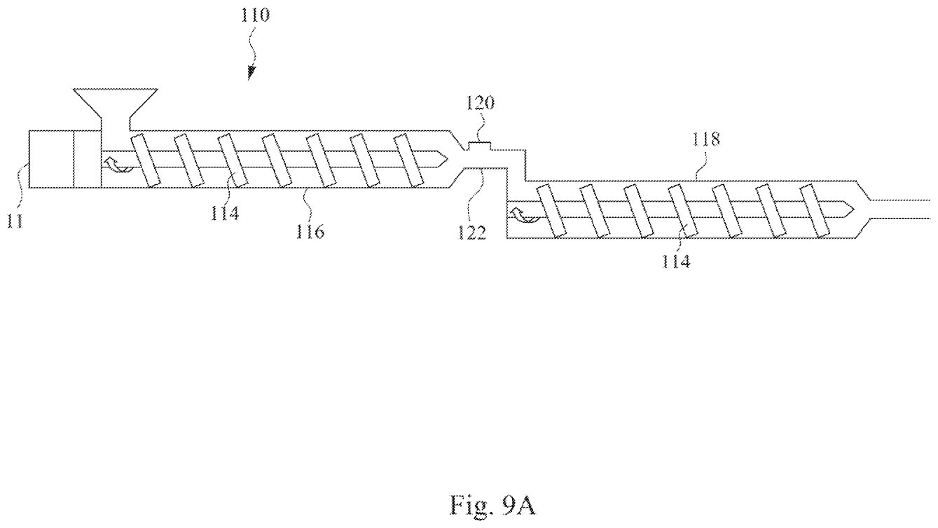

FIGS. 8A and 8B show schematic views of a double-flighted screw 90 and a triple-flighted screw 92, respectively. Compared with single-flight screws, multiple-flight screws have one or more additional sets of flights (helixes) 94 disposed on the screw shaft 96, and can achieve greater mixing per rotation of the screw, while also creating a narrower channel 98 between the flights of materials to flow through, leading to less pressure variation due to the rotation of the screw. While the barrier flight design can be generally considered as a type of multiple flight design, the term “multiple-flight” as used herein refers to helixes (or flights) with a constant flight pitch. In contrast, barrier flight designs have a variable pitch for separating solid and molten materials, as described above.

It should be noted that different types of flight designs may be configured on one single screw. For example, a barrier flight design, an inverse flight design, and a multiple flight design may be configured on one single screw according to embodiments of the present disclosure, with the barrier flight design separating molten and solid materials, the inverse flight design increasing mixing time, and the multiple flight design providing additional mixing per rotation. Other combinations of flight designs on a single screw are also possible.

Additionally or alternatively, the screw may comprise a variable shaft diameter. For example, the screw diameter at venting zone can be decreasing, allowing more space for materials. This lowers the pressure difference between the chamber and the atmosphere, preventing materials from overflowing, and also allowing more space for volatiles to escape. In another example, the screw shaft diameter may be smaller near the feeding port of the extruder, allowing more space between the screw shaft and the chamber to be occupied by solid material pellets. As the diameter of the screw shaft becomes larger along the axis of the chamber, the space between the screw shaft and the chamber becomes smaller, hence squeezing the materials and facilitate melting.

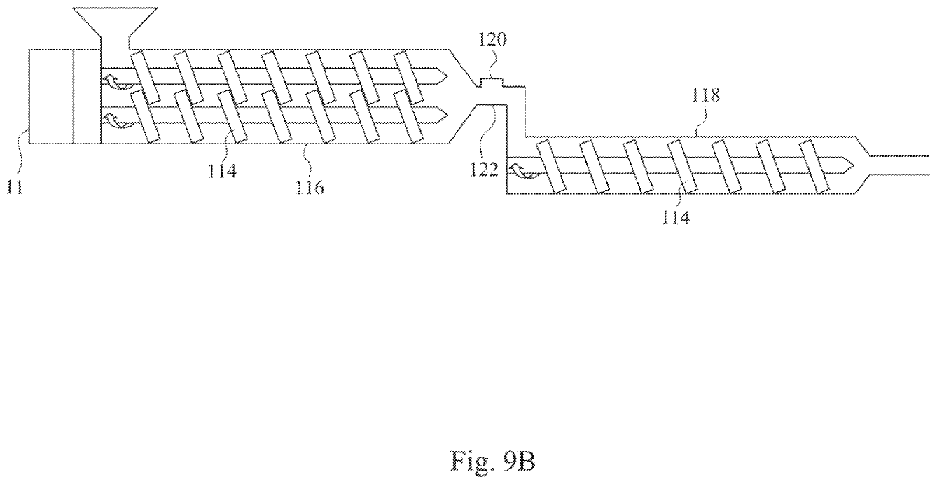

FIGS. 9A and FIG. 9B show two embodiments of a tandem-type extruder. Tandem-type extruders according to the present disclosure have two chambers connected in tandem, wherein a vent may be defined on the pathway connecting the two chambers for allowing volatiles inside the materials to escape through. In the tandem-type extruder 110 of FIG. 9A, one single-flight screw 114 is positioned inside each of the first chamber 116 and the second chamber 118, wherein a vent 120 is defined at a pathway 122 connecting the first chamber 116 and second chamber 118. In FIG. 9B, two single-flight screws 114 may be positioned inside the first chamber 114, while one single-flight screw 114 may be positioned inside the second chamber 118 that is connected to the first chamber 114 through a pathway 122. Similarly, a vent 120 can be defined on the pathway 122. It should be noted that the first chamber 114 does not necessarily have to have the same dimensions as the second chamber 118, and the screws positioned inside the first and second chambers 116, 118 do not necessarily have to be the same. Different types of screws may be positioned in first and second chambers 116, 118.

It should also be noted that other configurations of the screw and vent described above with regards to single chamber extruders can also be applied to tandem-type extruders. For example, the screws in the tandem-type extruders may also comprise one of a barrier flight design, an inverse flight design, and a multiple-flight design. Additionally or alternatively, the screw used in tandem-type extruders may have a variable shaft diameter. In another example, the vent of the tandem-type extruder can be connected to a powered ventilating device for facilitating volatiles inside the materials to escape the extruder.

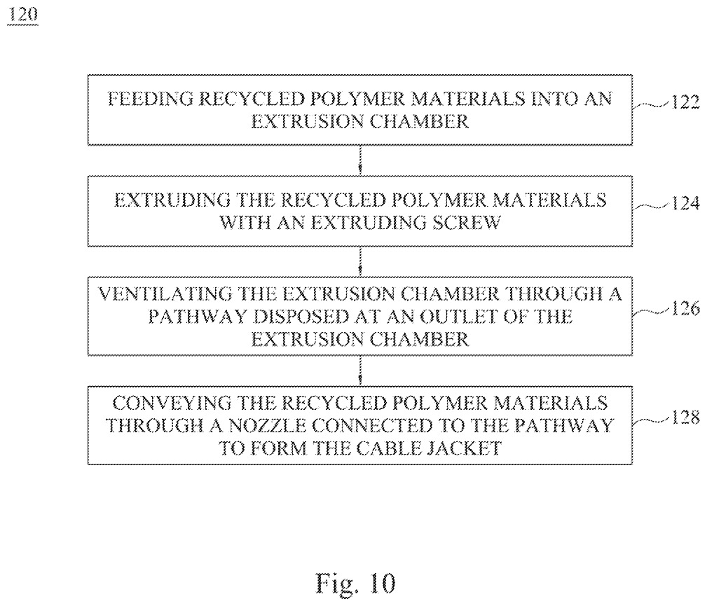

FIG. 10 shows a flow diagram for one embodiment of a method 120 for manufacturing a cable jacket. The method 120 begins at block 122 by feeding recycled polymer materials into an extrusion chamber through a feeding port. The recycled polymer materials may be in the form of pellets, granules, flakes or powders. In some examples, the feeding port may be a hopper or a kneading roller as described above. Optionally, the recycled polymer materials may be dehumidified with a dehumidifier before being fed into the extrusion chamber, in order to decrease volatiles or gas inside materials before the extrusion process. However, in some instances, dehumidifying the materials before extrusion is not necessary if the extruder can sufficiently force volatiles out of materials. In some cases where the extruder is connected to a vacuum pump under a negative pressure, the dehumidifying process before extrusion may be omitted.

At block 124, the recycled polymer materials are extruded with a screw which conveys the recycled polymer materials along the extrusion chamber. The screw may be a single-flight screw or a multiple-flight screw. Additionally or alternatively, the screw may have a variable shaft diameter. Furthermore, the screw may optionally comprise one of a barrier flight design, an inverse flight design, and a multiple-flight design, or a combination thereof.

At block 126, the extrusion chamber is ventilated through a pathway disposed at an outlet of the extrusion chamber, allowing volatiles inside the recycled polymer materials to escape from the extrusion chamber. Optionally, the pathway may be connected to a powered ventilating device such as a fan or a vacuum pump under negative pressure.

At block 128, the recycled polymer materials are conveyed through a nozzle connected to the pathway to form the cable jacket. The nozzle may be a die which has a shape of the cable jacket. Since volatiles have been forced out of the recycled polymer materials during the extrusion process, the formed cable jackets have less or minimal holes inside. Input of the nozzle may be conducted by a gear pump to control volume output of the recycled polymer materials to the nozzle.

The method 120 may be implemented through a single chamber extruder or a tandem-type extruder, wherein tandem-type extruders allow materials to go through an additional extrusion chamber before forming the cable jacket through the nozzle.

It will be apparent to those skilled in the art that various modifications and variations can be made without departing from the spirit or scope of the invention. Furthermore, features or configurations of one embodiment may be combined or implemented into other embodiments without further recitation.

What is claimed is:

1. A cable jacket extruder, comprising:
a chamber;
a feeding port disposed at one end of the chamber;
an extruding screw disposed inside the chamber;
a pathway connected to an outlet at another end of the chamber, the pathway having a vent; and
a nozzle connected to the pathway.

2. The cable jacket extruder of claim 1, wherein the vent is connected to a powered ventilating device.

3. The cable jacket extruder of claim 2, wherein the powered ventilating device is a fan or a vacuum pump.

4. The cable jacket extruder of claim 1, wherein the vent is in rectangular or oval shape with a long length or a long axis, respectively, extending along the pathway.

5. The cable jacket extruder of claim 1, wherein the feeding port comprises a kneading roller.

6. The cable jacket extruder of claim 1, further comprising a gear pump connected to the nozzle.

7. The cable jacket extruder of claim 1, wherein the chamber having a length to diameter (L/D) ratio in a range of 25 to 50.

8. The cable jacket extruder of claim 1, wherein the extruding screw is a plurality of extruding screws disposed in the chamber.

9. The cable jacket extruder of claim 1, wherein the extruding screw comprises at least one of a barrier flight, an inverse flight, and multiple flights.

10. The cable jacket extruder of claim 1, wherein the extruding screw comprises a variable shaft diameter.

11. A tandem-type cable jacket extruder, comprising:
a first chamber and a second chamber connected in tandem via a pathway;
a vent disposed on the pathway;
a feeding port disposed at one end of the first chamber; and
an extruding screw disposed in each of the first and second chambers.

12. The tandem-type cable jacket extruder of claim 11, wherein multiple extruding screws are disposed in one of the first and second chambers.

13. The tandem-type cable jacket extruder of claim 11, further comprising a gear pump disposed at one end of the second chamber.

14. The tandem-type cable jacket extruder of claim 11, wherein the vent is connected to a powered ventilating device.

15. The tandem-type cable jacket extruder of claim 11, wherein the extruding screw comprises at least one of a barrier flight, an inverse flight, and multiple flights.

16. A method for manufacturing a cable jacket, the method comprising:
feeding recycled polymer materials into an extrusion chamber;
extruding the recycled polymer materials with an extruding screw which conveys the recycled polymer materials along the extrusion chamber;
ventilating the extrusion chamber through a pathway disposed at an outlet of the extrusion chamber, allowing volatiles inside the recycled polymer materials to escape from the extrusion chamber; and
conveying the recycled polymer materials through a nozzle connected to the pathway to form the cable jacket.

17. The method of claim 16, further comprising dehumidifying the recycled polymer materials before feeding the recycled polymer materials into the extrusion chamber.

18. The method of claim 16, wherein ventilating the extrusion chamber is conducted through a vent disposed on the pathway by a vacuum pump under a negative pressure.

19. The method of claim 16, wherein conveying the recycled polymer materials through the nozzle is conducted by a gear pump to control outputting of the recycled polymer materials to the nozzle.

20. The method of claim 16, further comprising entering the recycled polymer materials into a second extrusion chamber through the pathway before forming the cable jacket through the nozzle.
